(19) United States
(12) Patent Application Publication
(10) Pub. No.: US 2016/0141102 A1
(43) Pub. Date: May 19, 2016

(54) SUBSTRATE-LESS ELECTRONIC COMPONENT AND THE METHOD TO FABRICATE THEREOF

(71) Applicant: CYNTEC CO., LTD., HSINCHU (TW)

(72) Inventors: Shih-Hsien Tseng, Hsinchu (TW); CHIA PEI CHOU, Hsinchu (TW); YI-TING CHIANG, Hsinchu (TW); CHANG-MING TSAI, Hsinchu (TW)

(21) Appl. No.: 14/940,171

(22) Filed: Nov. 13, 2015

Related U.S. Application Data
(60) Provisional application No. 62/079,575, filed on Nov. 14, 2014.
(60) Provisional application No. 62/083,325, filed on Nov. 24, 2014.

(51) Int. Cl. H01F 41/04; H01F 27/29; H01F 27/28

(52) U.S. Cl. CPC H01F 41/042; H01F 27/2804; H01F 27/29; H01F 2027/2809

(57) ABSTRACT

An electronic component is disclosed, the electronic component comprising: a conductive structure, comprising a plurality of conductive layers separated by a plurality of insulating layers, wherein the plurality of conductive layers and the plurality of insulating layers are stacked in a vertical direction, wherein the plurality of conductive layers forms at least one coil, wherein each of the coil is formed along the vertical direction across said plurality of conductive layers, wherein the plurality of insulating layers are not supported by a substrate.

### CROSS-REFERENCES TO RELATED APPLICATIONS

This application claims the benefit of U.S. Provisional Patent Application No. 62/079,575 filed on Nov. 14, 2014 and U.S. Provisional Patent Application No. 62/083,325 filed on Nov. 24, 2014, which are hereby incorporated by reference herein and made a part of specification.

### BACKGROUND OF THE INVENTION

1. Field of the Invention

The present invention relates to a method of forming an inductor, and more particularly, a method of forming an inductor using metal layers on a substrate.

2. Description of the Prior Art

A technique for manufacturing a low temperature co-fired ceramic (hereinafter, being referred to as “LTCC”) substrate is a process in which an internal electrode and passive elements (R, L, and C) for given circuits are formed in a green sheet made of glass ceramic by a screen printing method using a metal with high electric conductivity such as Ag, Cu, etc., and a plurality of the green sheets are stacked vertically and then fired (generally at less than 1,000° C.) so as to manufacture MCM (multi-chip modules) and multi-chip packages.

Since the ceramic substrate and the metallic elements are co-fired, the LTCC technique can form the passive elements (R, L, and C) within a module, thereby obtaining a complex configuration including many components and being advantageous in terms of miniaturization.

The LTCC multilayer substrate is formed by forming circuits in a single ceramic substrate and vertically stacking a plurality of the ceramic substrates. Therefore, external terminals to be connected to the outside must be formed on an outer surface of the LTCC substrate and electrically connected to circuit patterns within the substrate.

As communications technology such as mobile devices are being developed, more and more features are being added into the mobile devices without having to increase the size of the body of mobile devices. This means that new circuitries may be added inside the body of the mobile devices without removing any of the conventionally existing circuitries. Furthermore, the increase in the bandwidth used in communication technology may require antennas to increase in size. Conventionally, antennas are formed using inductors. Inductors are used to emit or receive signals according to the requirement of the communication technology. As the bandwidth of the communication technology increases, there may be a need to increase the inductance of the inductors being used. The inductance of the inductor may be increased by increasing the windings of the inductors. With the increase in the windings, the area needed to form the inductors may increase. With the restrictions on the area of mobile devices, there is a need to develop a method of forming an inductor having higher inductance without having to increase the area of the inductor.

### SUMMARY OF THE INVENTION

These and other objectives of the present invention will no doubt become obvious to those of ordinary skill in the art after reading the following detailed description of the preferred embodiment that is illustrated in the various figures and drawings.

The inductor of the present invention can be made by lithographic process or film process such as thin-film process, wherein a coil can be disposed in insulating layers and the coil has a plurality of turns of winding wire and each turn of the winding wire of the coil is formed across a plurality of conductive layers by electrically connecting a corresponding conductive pattern on each of the a plurality of conductive layers. In one embodiment, each turn of the winding wire is substantially perpendicular to the bottom-side (B-side) electrode of the inductor.

For the conventional inductor, the B-side electrode is parallel to each turn of the coil windings, which will produce shielding effect of the magnetic flux when current flowing into and out of the inductor, as a result, the quality factor (Q factor) of the inductor will be reduced; on the contrary, the B-side electrode of the inductor of the present invention can be perpendicular to each turn of the coil windings, and hence the shielding effect of the magnetic flux when current flowing into and out of the inductor can be reduced, thereby increasing the Q factor of the inductor.

In one embodiment, an electronic component is disclosed, the electronic component comprising: a plurality of conductive layers separated by a plurality of insulating layers, wherein a coil comprising at least one winding turn is formed by the plurality of conductive layers, wherein each of the at least one winding turn is formed by electrically connecting a corresponding conductive pattern on each of the plurality of conductive layers, wherein the plurality of conductive layers and the plurality of insulating layers are not supported by a substrate.

In one embodiment, said at least one coil is formed by a plurality of thin-film metal layers that are electrically connected, wherein a first thin-film metal layer is disposed on a first insulating layer, wherein a second insulating layer is disposed on a patterned area of the first thin-film metal layer and filled into a non-patterned area of the first thin-film metal layer, wherein the plurality of insulating layers separating said thin-film metal layers are not supported by a substrate.

In one embodiment, the electronic component is an inductor, wherein an electrode is disposed on the bottom surface of the inductor and electrically connected to the coil, wherein each winding turn of the coil is perpendicular to said portion of the electrode disposed at the bottom surface of the inductor.

In one embodiment, the electronic component further comprising a first electrode, wherein an inner surface of the first electrode adjacent to the at least one coil comprises at least one recess, wherein a first portion of the plurality of insulating layers is filled into said at least one recess.

In one embodiment, the electronic component further comprising a second electrode, wherein an inner surface of the second electrode adjacent to the at least one coil comprises at least one recess, wherein a portion of the plurality of insulating layers is filled into said at least one recess.

In one embodiment, the electronic component is a choke or inductor.

one embodiment, the plurality of insulating layers comprise a top insulating layer, a plurality of median insulating layers and a bottom insulation layer, wherein the at least one coil is substantially disposed in the plurality of the median insulating layers.

In one embodiment, the thickness of the top insulating layer is greater than that of each of the plurality of median insulating layers.

In one embodiment, each of the insulating layer is a dielectric layer and each of the conductive layer is a metal layer, wherein each metal layer has a metal track formed between the first electrode and the second electrode; a plurality of vias disposed in the dielectric layer to electrically connect the metal tracks of the metal layers, wherein each of the first electrode and the second electrode is perpendicular to a corresponding metal track.

In one embodiment, the inner surface of the first electrode has a first plurality of protrusions and the inner surface of the second electrode has a second plurality of protrusions alternating with the first plurality of protrusions from layer to layer.

In one embodiment, said corresponding metal track is hook shaped metal track. In one embodiment, the first and second electrodes have different shapes from each other from layer to layer.

In one embodiment, each of the first and second electrodes extends from a middle layer of the plurality of the conductive layers to the bottom layer of the plurality of the conductive layers.

In one embodiment, each of the first and second electrodes extends from the top layer of the plurality of the conductive layers to the bottom layer of the plurality of the conductive layers.

In one embodiment, a first conductive layer of the plurality of the conductive layers and a second conductive layer of the plurality of the conductive layers are separated by a first insulating layer, wherein a first metal track pattern on the first conductive layer and a second metal track on the second conductive layer have a same shape, wherein the first metal track and the second metal track are stacked on and electrically connected to each other through the first insulating layer.

In one embodiment, said same shape of the first metal track on the first conductive layer and the second metal track on are aligned to each other. In one embodiment, a method for forming an electronic component is disclosed, the method comprising: providing a substrate; forming a plurality of conductive layers separated and a plurality of insulating layers on the substrate, wherein the plurality of conductive layers are separated by the plurality of insulating layers, wherein a coil comprising at least one winding turn is formed by the plurality of conductive layers, wherein each of the at least one winding turn is formed by electrically connecting a corresponding conductive pattern on each of the plurality of conductive layers; and removing the substrate from the plurality of insulating layers.

In one embodiment, the electronic component is a choke or inductor.

In one embodiment, the method according further comprising disposing a buffer layer on the substrate, wherein the plurality of conductive layers and the plurality of are formed on the buffer layer; and removing the buffer layer after removing the substrate. In one embodiment, said at least one coil is formed by a plurality of thin-film metal layers that are electrically connected, wherein a first thin-film metal layer is disposed on a first insulating layer, wherein a second insulating layer is disposed on a patterned area of the first thin-film metal layer and filled into a non-patterned area of the first thin-film metal layer, wherein the plurality of insulating layers separating said thin-film metal layers are not supported by a substrate.

### BRIEF DESCRIPTION OF THE DRAWINGS

FIG. 1 illustrates a flowchart of a method of forming an inductor according to another embodiment of the present invention.

FIG. 2 illustrates an exemplary embodiment of the inductor formed in the method in FIG. 1.

FIG. 3 illustrates a top view of the inductor formed using the method in FIG. 1.

FIG. 4 illustrates a cross section view a winding turn of the inductor formed using the method in FIG. 1.

FIGS. 5-8 illustrate graphs showing significant improvements of the inductor according to an embodiment of the present invention as compared to conventional inductors.

### DETAILED DESCRIPTION

The present invention discloses a substrate-less electronic component. The substrate-less electronic component can be manufactured by performing film process, such as a lithography process, etching process or thin-film process, on a plurality of conductive layers or insulating layers on the substrate before the substrate is removed. For a device formed on a substrate used for a carrier, the external electrical connection path is often routed along the lateral surface of the substrate or via a through hole so that a longer electrical connection path is needed. Compared to the device formed on the substrate, the thickness of substrate-less device in the present invention is smaller and the device has a better electrical performance.

The plurality of insulating layers can comprise at least one of epoxy, oxide, a polymer-based material or a magnetic material so that film process, such as a lithography process, etching process or thin-film process, can be applied to the plurality of insulating layers and the coil for patterning. The coil can be made of any suitable material, such as Cu, Ag, or any other suitable metallic material. The coil can be a multilayer coil, and each layer of the multilayer coil is a conductive layer patterned on an insulating layer. More specifically, the insulating layer is an interlayer between two adjacent conductive layers and there is a through hole in the insulating layer for electrically connecting two adjacent conductive layers. The number of conductive layers of the multilayer coil can be controlled to increase the inductance of the coil.

In one embodiment, the plurality of insulating layers substantially comprise a top insulating layer, a plurality of median insulating layers, and a bottom insulating layer. More specifically, the coil is disposed in the plurality of the median insulating layers. The top insulating layer is disposed on the plurality of median insulating layers to protect the conductive element from suffering from external mechanical interference. Preferably, the thickness of the top insulating layer is greater than that of each of the plurality of median insulating layers. The bottom insulating layer is disposed below the plurality of median insulating layers.

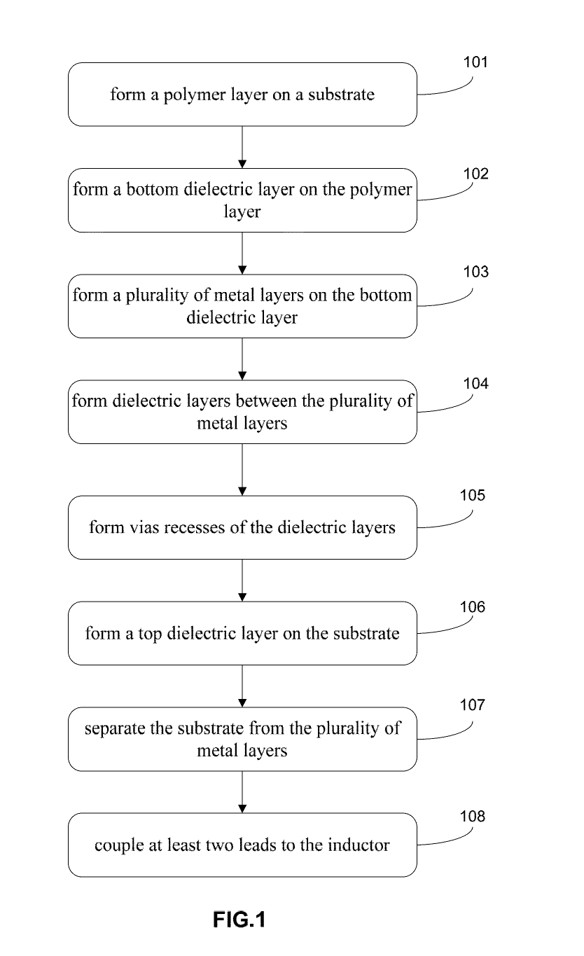

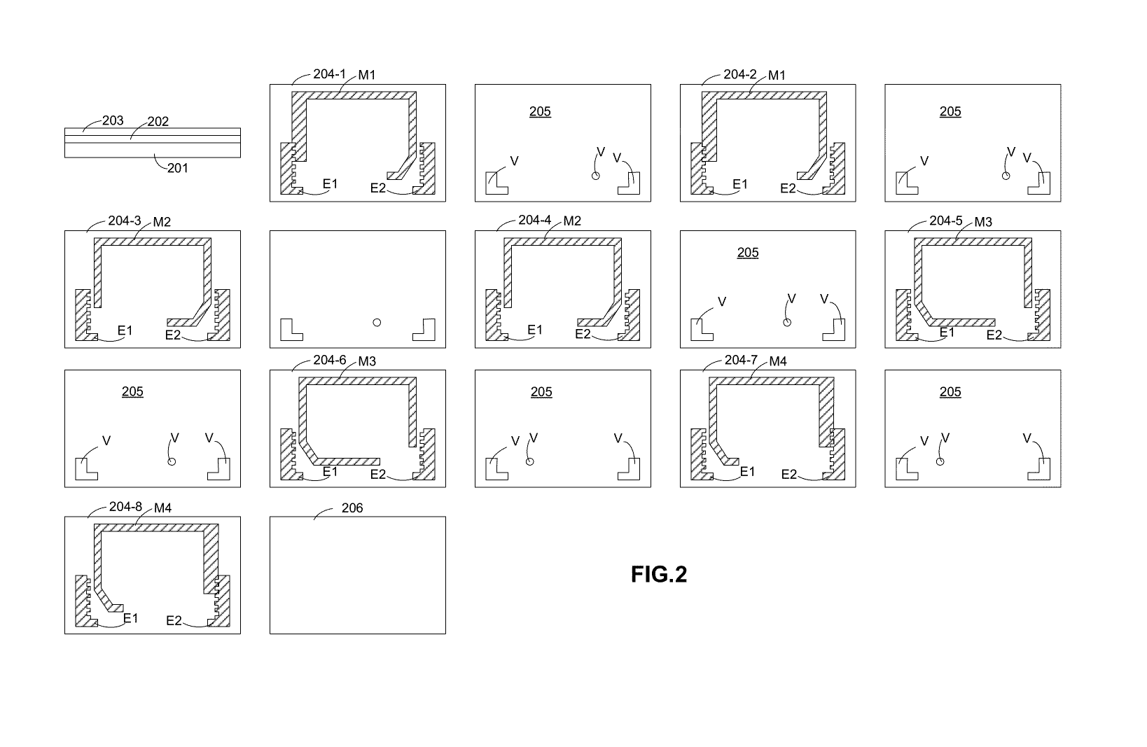

FIG. 1 illustrates a flowchart of a method of forming an inductor according to an embodiment of the present invention. And, FIG. 2 illustrates an exemplary embodiment of the inductor 200 formed in the method in FIG. 1.

As shown in FIG. 1, in step 101, a buffer layer 202, such as the polymer layer, is formed on the substrate 201. The buffer layer 202 is used as a separation layer between the bottom dielectric layer 203 and the substrate 201. The polymer layer 202 would prove useful during step 107 of the method where the substrate 201 is to be separated from the plurality of metal layers 204.

In step 102, a bottom dielectric layer 203 may be formed on the polymer layer 202. The bottom dielectric may be formed using an insulating material or a material that is a very poor conductor of electric current. The bottom dielectric layer 203 may be formed to serve as a lateral surface for the inductor 200 that encloses the metal layers 204 to protect the inductor 200 form outside environment.

In step 103, a plurality of metal layers 204 may be formed on the bottom dielectric layer 203. Each of the plurality of metal layers 204 may have a metal track M formed between two electrodes E1 and E2. The metal track M may serve as a winding of the inductor 200. The number of winding turns may determine the number of times the magnetic flux lines link the circuit to increase the magnetic field produced by the inductor. In this way, the inductance of the inductor increases as the number of metal track M increases. Thus, it can be said that the number of metal layers 204 used during fabrication of the inductor 200 may have a direct correlation to the inductance produced by the inductor 200. The metal tracks M may be formed to have a hook shaped structure. The inductor 200 may have at least three types of metal track M. As an exemplary embodiment, the inductor 200 shown in FIG. 2 may have the at least three types of metal track M including a first metal track M1, a second metal track M2, a third metal track M3, and a fourth metal track M4. Each of the at least three types of metal track M may be repeatedly formed in separate metal layers as shown in FIG. 2. The first electrodes E1 and the second E2 formed on each of the plurality of metal layers 204 may be formed at the same time as the metal tracks M. In some metal layers, a metal track M may be coupled to an electrode E.

That is, conductive patterns on multiple conductive layers, such as metal tracks or traces on the multiple metal layers 204, are electrically connected from metal layer to metal layer in a vertical direction so as to form a winding turn of a coil. Multiple winding turns can be electrically connected to each other via metal tracks or traces on the conductive layers so as to form a coil with multiple winding turns, wherein each winding turn of the coil is formed by electrically connecting the corresponding conductive pattern, such as metal tracks or traces, on each of said conductive layers.

As shown in FIG. 2, the first metal track M1 may be formed to be coupled to the first electrode E1. The fourth metal track M4 may be formed to be coupled to the electrode E2. The electrodes E1 and E2 may be formed with different shapes at different metal layers 204. For example, an electrode E1 at the first metal layers 204 may have greater number of recesses as compared to an electrode E1 at the second metal layers 204. In the same way, an electrode E2 at the first metal layers 204 may have greater number of recesses as compared to an electrode E2 at the second metal layers 204.

In step 104, dielectric layers 205 may be formed between the plurality of metal layers 204. The dielectric layers 205 may serve as an insulating layer for separating the metal layers 204 from each other. The dielectric layers 205 may have recesses.

In step 105, vias V may be formed on recesses of the dielectric layers 205 to connect the plurality of metal layers 204 to each other. At least one via V may be formed to couple metal tracks M to each other. At least one via V may be formed to couple the electrodes E1 of different metal layers 204 to each other. At least one via V may be formed to couple the electrodes E2 of different metal layers 204 to each other.

In step 106, a top dielectric layer 206 may be formed on the substrate 201 after the plurality of metal layers 204 have been formed. The top dielectric layer 206 may be formed in the same way as the bottom dielectric layer 203. The top dielectric layer 206 may be formed to serve as a lateral surface for the inductor 200 that encloses the metal layers 204 to protect the inductor 200 form outside environment.

In step 107, the substrate 201 may be separated from the plurality of metal layers 204. The method of forming the inductor 200 may make use of the substrate 201 as a platform to form the inductor 200. The substrate 201 is not an actual part of the inductor 200. The substrate 201 may be separated from the plurality of metal layers 204 by mechanically or chemically removing the polymer 202. When using the mechanical means, the substrate 201 may be pulled away from the bottom dielectric layer 203. When using the chemical means, the polymer 202 attaching the substrate 201 and the bottom dielectric layer 203 may be heated to decrease the viscosity of the polymer 202 to detach the substrate 201 from the bottom dielectric layer 203. The substrate 201 may be a glass wafer or a silicon wafer. At present, the substrate 201 may have a size large enough such that a plurality of inductors 200 may be formed on the substrate 201 simultaneously. After separating the substrate 201 from the plurality of metal layers 204, the plurality of inductors 200 may be separated from each other through a dicing process.

In step 108, metal layers L1 and L2 may be disposed on the first electrode E1 and the second electrode E2 respectively such that L1 and L2 can be soldered on a PCB board.

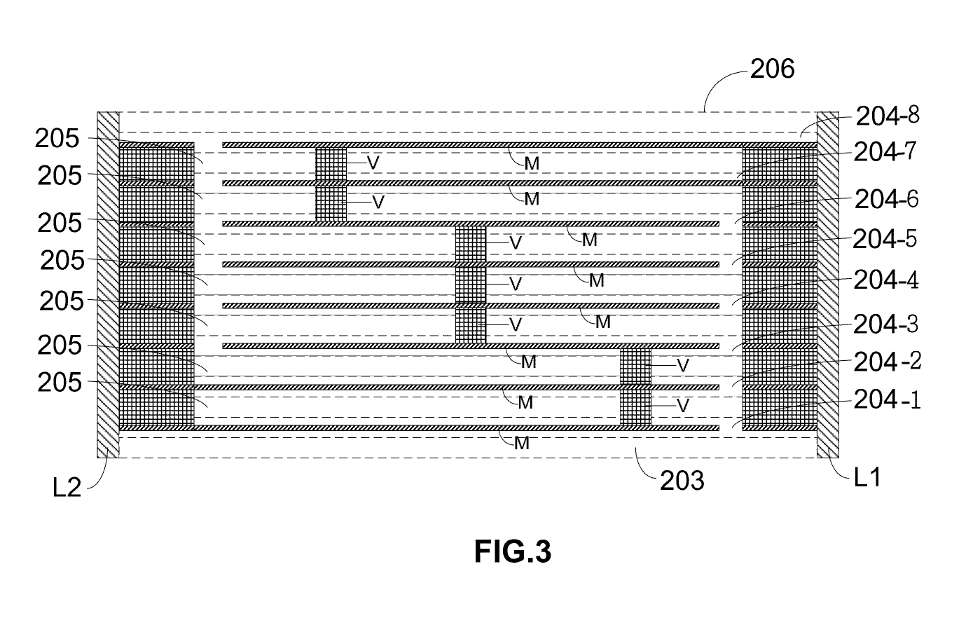

FIG. 3 illustrates a top view of the inductor 200 formed using the method in FIG. 1.

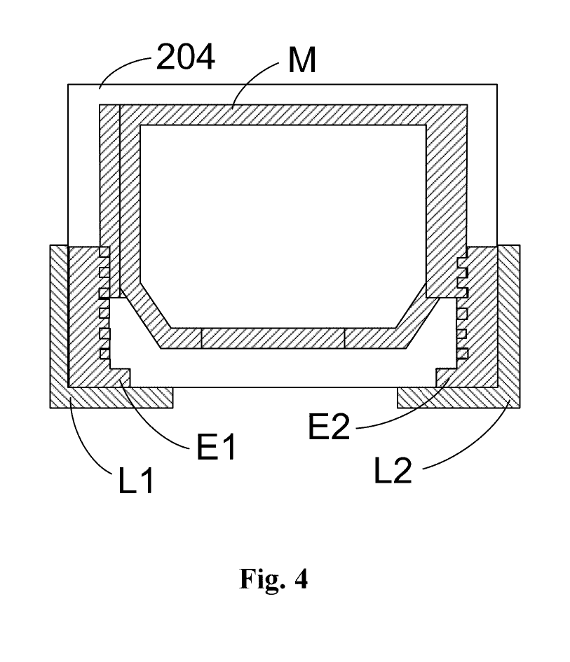

FIG. 4 illustrates a cross section view showing a winding turn of the inductor 200 made according to the method in FIG. 1.

As compared to conventional inductors where each of the windings is parallel to the bottom-side electrode, the inductor presented in the present invention can have each of the windings (metal tracks) M perpendicular to the bottom-side electrode E1, E2, wherein L1 and L2 are metal layers for forming leads which can be soldered on a PCB board, as shown in FIG. 4.

As shown in FIG. 3, the exemplary embodiment of the inductor 200 shown in FIG. 2 has an inductor formed using eight metal layers 204-1, 204-2, 204-3, 204-4, 204-5, 204-6, 204-7, 204-8. Within the eight metal layers 204-1, 204-2, 204-3, 204-4, 204-5, 204-6, 204-7, 204-8, four types of metal track M including a first metal track M1, a second metal track M2, a third metal track M3, and a fourth metal track M4 may be formed for forming the coil of the inductor 200. Furthermore, each of the metal tracks M are formed between two electrodes E1 and E2. A same type of metal tracks can be stacked over each other on different metal layers. That is, two of the metal tracks may be the first metal track M1, two of the metal tracks may be the second metal track M2, two of the metal tracks may be the third metal track M3, and two of the metal tracks may be the fourth metal track M4. The first metal track M1 may be formed to be coupled to the electrode E1. The fourth metal track M4 may be formed to be coupled to the electrode E2. The shape of the electrode E1 for the each of the metal layers 204 may be different from each other. For example, the first metal layer 204-1 may have a different electrode shape from the second metal layer 204-2. The shape of the electrode E1 may be different for all the metal layers 204 or may be alternating between the metal layers 204. In the exemplary embodiment, the shape of the electrode E1 may be alternating between metal layers 204. The shape of the electrode E1 for metal layers 204-1, 204-3, 204-5, and 204-7 may be the same and the shape of the electrode E1 for metal layers 204-2, 204-4, 204-6, and 204-8 may be the same.

As shown in FIG. 2, the electrode E1 in the first metal layer 204-1 and the second metal layer 204-2 may have a plurality of protrusion. The plurality of protrusion in the electrode E1 of the first metal layer 204-1 may be alternating in position with the plurality of protrusion in the electrode E1 of the second metal layer 204-2. Likewise, the shape of the electrode E2 for the each of the metal layers 204 may be different from each other. For example, the electrode E2 of the first metal layer 204-1 may have a different shape than that of the electrode E2 of the second metal layer 204-2. The shape of the electrode E2 may be different for all the metal layers 204 or may be alternating between the metal layers 204. In the exemplary embodiment, the shape of the electrode E2 may be alternating between metal layers 204. The shape of the electrode E2 for metal layers 204-1, 204-3, 204-5, and 204-7 may be the same and the shape of the electrode E2 for metal layers 204-2, 204-4, 204-6, and 204-8 may be the same. As shown in FIG. 2, the electrode E2 in the first metal layer 204-1 may have a plurality of protrusions and the electrode E2 in the second metal layer 204-2 may have a plurality of protrusions. The plurality of protrusions in the electrode E2 of the first metal layer 204-1 may be alternating in position with the plurality of protrusions in the electrode E2 of the second metal layer 204-2.

The protrusions in the electrodes E1 and E2 are formed such that filling such as dielectric materials may easily be deposited to the recesses formed in the metal layers 204 without forming gaps or air pockets, which will increase the contact areas between the dielectric materials and the electrodes so as to strengthen the adhesion between the dielectric materials and the electrodes. The metal layers 204 are separated from each other by dielectric layers 205, wherein each of the dielectric layers 205 may have recesses where vias V are formed. Vias V1 of the dielectric layers 205 may be used to couple the electrodes E1 of the metal layers 204. Vias V2 of the dielectric layers 205 may be used to couple the electrodes E2 of the metal layers 204. Vias VM of the dielectric layers 205 may be used to couple the metal tracks M of the metal layers 204. Positioning of the vias VM may be dependent on the type of metal track M to be coupled. Furthermore, the metal layers 204 and the dielectric layers 205 are enclosed between the top dielectric layer 206 and bottom dielectric layer 203 to protect the inductor 200 from outside environment.

The inductor of the present invention can be made by a lithographic process or film process such as thin-film process, wherein a coil can be disposed in insulating layers and wherein the coil has a plurality of turns of windings and each turn of the winding of the coil is formed across a plurality of conductive layers by electrically connecting a corresponding conductive pattern on each of the a plurality of conductive layers, wherein each turn of the winding wire is substantially perpendicular to the bottom-side (B-side) electrode of the inductor.

For the conventional inductor, the B-side electrode is parallel to each turn of the coil windings, which will produce shielding effect of the magnetic flux when current flows into and out of the inductor, as a result, the quality factor (Q factor) of the inductor will be reduced. On the contrary, the B-side electrode of the inductor of the present invention can be perpendicular to each turn of the coil windings, and hence the shielding effect of the magnetic flux when current flows into and out of the inductor can be reduced, thereby increasing the Q factor of the inductor.

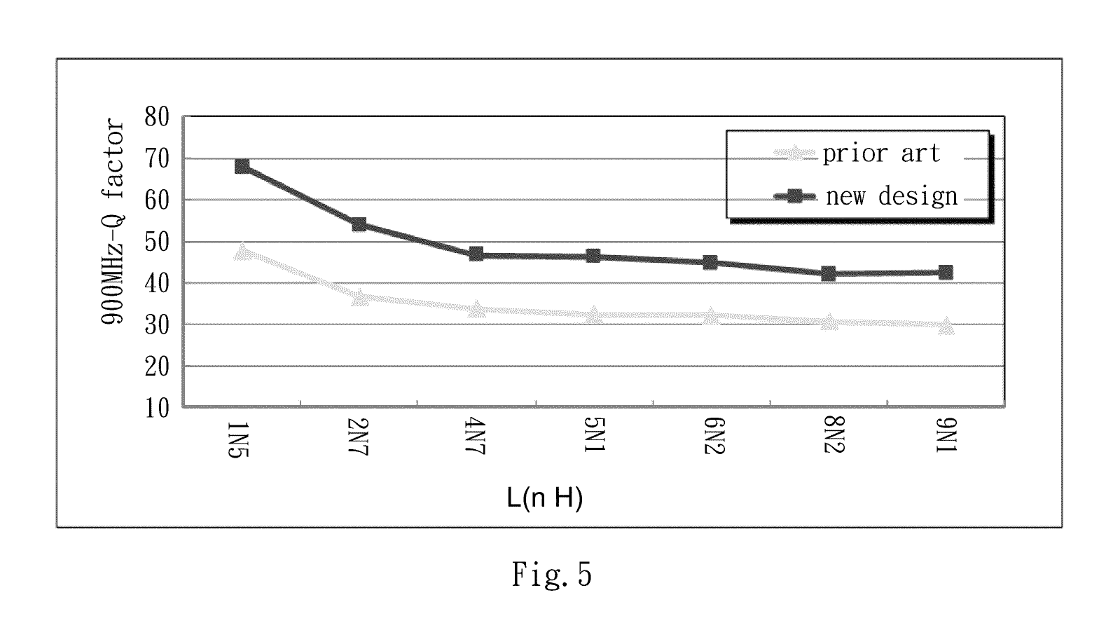

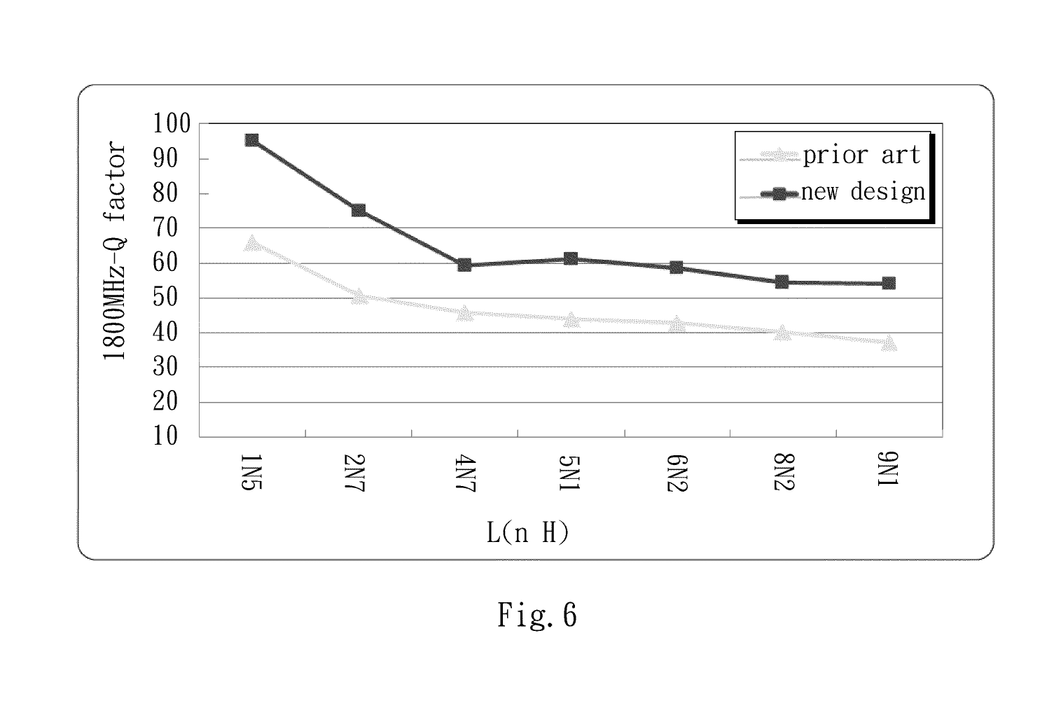

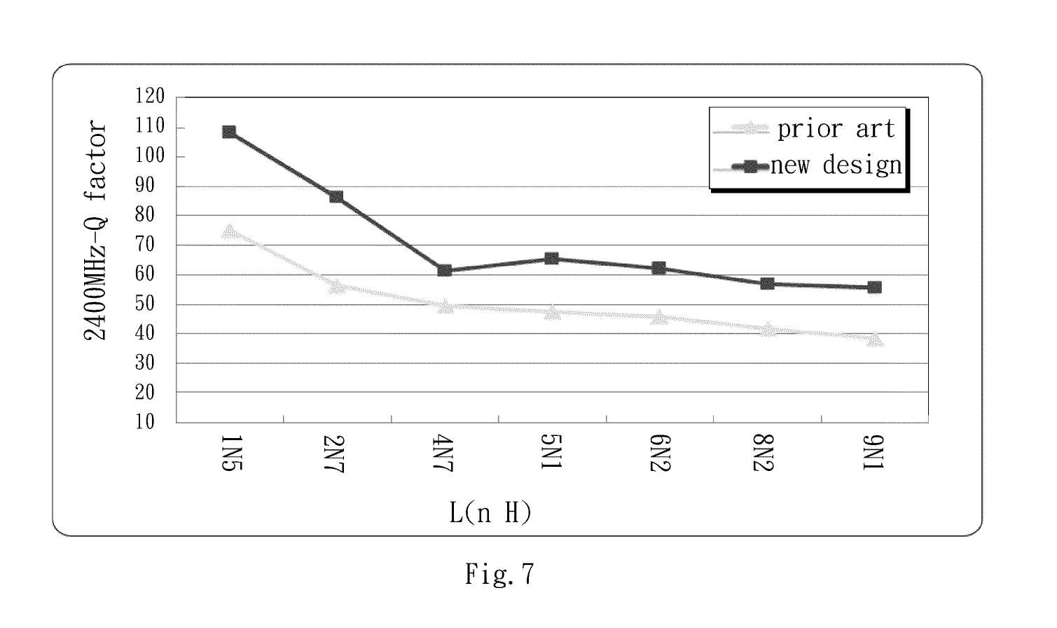

FIGS. 5-8 illustrate graphs showing significant improvements of the inductor according to an embodiment of the present invention as compared to conventional inductors. FIG. 5 shows the Q factor improvement over the prior arts at 900 Mhz; FIG. 6 shows the Q factor improvement over the prior arts at 1800 Mhz; and FIG. 7 shows the Q factor improvement over the prior arts at 2400 Mhz, which can be summarized by Table 1 as shown below.

TABLE 1

| | 900 MHz | 1800 MHz | 2400 MHz |
|---|---|---|---|
| | Q Factor | Q Factor | Q Factor |
| | Increase | Increase | increase |
| L(n H) | percentage | percentage | percentage |
| 1.5(1N5) | 42% | 44% | 44% |
| 2.7(2N7) | 47% | 48% | 53% |
| 4.7(4N7) | 38% | 29% | 24% |
| 5.1(5N1) | 43% | 39% | 38% |
| 6.2(6N2) | 39% | 36% | 36% |
| 8.2(8N2) | 37% | 35% | 35% |
| 9.1(9N1) | 42% | 45% | 45% |

Form the above table, we can see that the Q factor can be improved over the prior arts from 29% to 48% with respect to the frequency of the current flowing through the inductor and the inductance of the inductor.

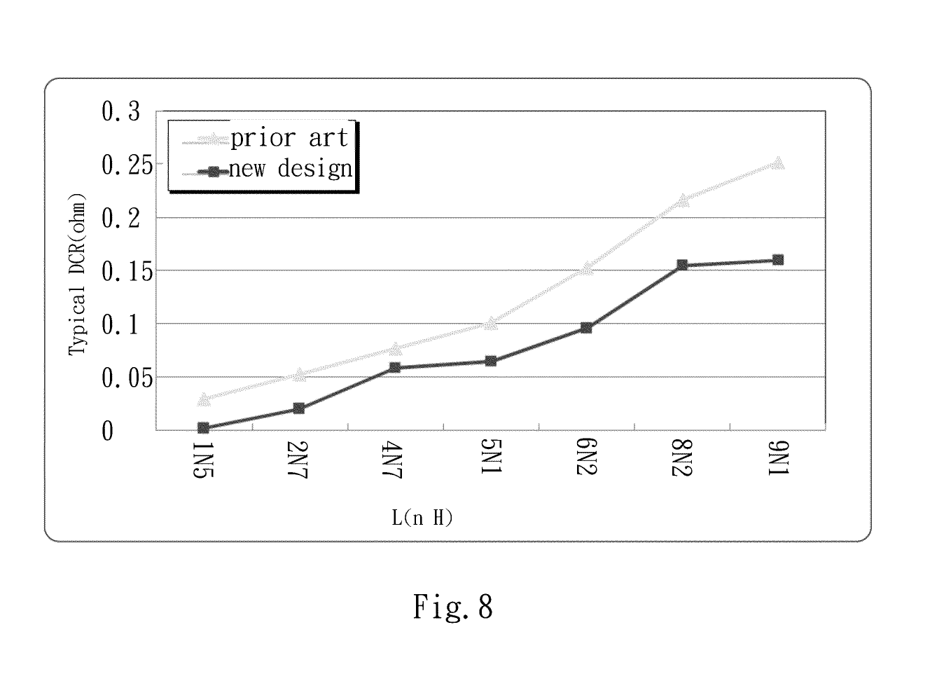

Furthermore, direct current resistance (DCR) of the Inductor of the present invention can be reduced as well as shown in FIG. 8, which can be summarized by Table 2 as shown below.

TABLE 2

| | DCR |
|---|---|
| L(n H) | reduced percentage |
| 1.5(1N5) | −93% |
| 2.7(2N7) | −62% |
| 4.7(4N7) | −24% |
| 5.1(5N1) | −36% |
| 6.2(6N2) | −37% |
| 8.2(8N2) | −29% |
| 9.1(9N1) | −37% |

Based on Table 2, the DCR of the inductor of the present invention can be reduced from 24% to 93%, as compared with the prior arts.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic component, comprising: a plurality of conductive layers separated by a plurality of insulating layers, wherein a coil comprising at least one winding turn is formed by the plurality of conductive layers, wherein each of the at least one winding turn is formed by electrically connecting a corresponding conductive pattern on each of the plurality of conductive layers, wherein the plurality of conductive layers and the plurality of insulating layers are not supported by a substrate.

2. The electronic component of claim 1, wherein said at least one winding turn is formed by a plurality of thin-film metal layers that are electrically connected, wherein a first thin-film metal layer is disposed on a first insulating layer, wherein a second insulating layer is disposed on a patterned area of the first thin-film metal layer and filled into a non-patterned area of the first thin-film metal layer, wherein the plurality of insulating layers separating said thin-film metal layers are not supported by a substrate.

3. The electronic component of claim 1, wherein the electronic component is an inductor, wherein an electrode having a portion disposed on the bottom surface of the inductor and electrically connected to the coil, wherein each winding turn of the coil is perpendicular to said portion of the electrode disposed on the bottom surface of the inductor.

4. The electronic component of claim 1, wherein the electronic component is an inductor, further comprising a first electrode, wherein an inner surface of the first electrode comprises at least one first recess for increasing the contact areas of the first electrode.

5. The electronic component of claim 4, further comprising a second electrode, wherein an inner surface of the second electrode comprises at least one second recess, wherein a first portion of the plurality of insulating layers is filled into said at least one first recess, and a second portion of the plurality of insulating layers is filled into said at least one second recess.

6. The electronic component of claim 1, wherein the electronic component is a choke or inductor.

7. The electronic component of claim 1, wherein the plurality of insulating layers comprise a top insulating layer, a plurality of median insulating layers and a bottom insulation layer, wherein the at least one coil is substantially disposed in the plurality of the median insulating layers.

8. The electronic component of claim 7, wherein the thickness of the top insulating layer is greater than that of each of the plurality of median insulating layers.

9. The electronic component of claim 5, wherein each of the insulating layer is a dielectric layer and each of the conductive layer is a metal layer, wherein each metal layer has a metal track formed between the first electrode and the second electrode; a plurality of vias disposed in the dielectric layer to electrically connect the metal tracks of the metal layers, wherein each of the first electrode and the second electrode is perpendicular to a corresponding metal track.

10. The electronic component of claim 4, wherein the inner surface of the first electrode has a first plurality of protrusions and the inner surface of the second electrode has a second plurality of protrusions alternating with the first plurality of protrusions from layer to layer.

11. The electronic component of claim 9, wherein said corresponding metal track is hook shaped metal track.

12. The electronic component of claim 9, wherein the first and second electrodes have different shapes from each other from layer to layer.

13. The electronic component of claim 9, wherein each of the first and second electrodes extends from a middle layer of the plurality of the conductive layers to the bottom layer of the plurality of the conductive layers.

14. The electronic component of claim 9, wherein each of the first and second electrodes extends from the top layer of the plurality of the conductive layers to the bottom layer of the plurality of the conductive layers.

15. The electronic component of claim 1, wherein a first conductive layer of the plurality of the conductive layers and a second conductive layer of the plurality of the conductive layers are separated by a first insulating layer, wherein a first metal track pattern on the first conductive layer and a second metal track on the second conductive layer have a same shape, wherein the first metal track and the second metal track are stacked on and electrically connected to each other through the first insulating layer.

16. The electronic component of claim 15, wherein said same shape of the first metal track on the first conductive layer and the second metal track on are aligned to each other.

17. A method for forming an electronic component, the method comprising:
providing a substrate;
forming a plurality of conductive layers separated and a plurality of insulating layers on the substrate, wherein the plurality of conductive layers are separated by the plurality of insulating layers, wherein a coil comprising at least one winding turn is formed by the plurality of conductive layers, wherein each of the at least one winding turn is formed by electrically connecting a corresponding conductive pattern on each of the plurality of conductive layers; and
removing the substrate from the plurality of conductive layers and the plurality of insulating layers.

18. The method of claim 17, wherein the electronic component is made by a lithography process or a thin-film process.

19. The method of claim 17, further comprising disposing a buffer layer on the substrate, wherein the plurality of conductive layers and the plurality of are formed on the buffer layer; and removing the buffer layer after removing the substrate.

20. The method of claim 17, wherein said at least one winding turn is formed by a plurality of thin-film metal layers that are electrically connected, wherein a first thin-film metal layer is disposed on a first insulating layer, wherein a second insulating layer is disposed on a patterned area of the first thin-film metal layer and filled into a non-patterned area of the first thin-film metal layer, wherein the plurality of insulating layers separating said thin-film metal layers are not supported by a substrate.
